(19) United States
(12) Patent Application Publication
(10) Pub. No.: US 2015/0082445 A1
(43) Pub. Date: Mar. 19, 2015

(54) INFORMATION PROCESSING METHOD AND ELECTRONIC DEVICE

(71) Applicants: Lenovo (Beijing) Co., Ltd., Beijing (CN); Beijing Lenovo Software Ltd., Beijing (CN)

(72) Inventors: Shi Chen, Beijing (CN); Changsheng Guo, Beijing (CN)

(73) Assignees: Lenovo (Beijing) Co., Ltd., Beijing (CN); Beijing Lenovo Software Ltd., Beijing (CN)

(21) Appl. No.: 14/229,514

(22) Filed: Mar. 28, 2014

(30) Foreign Application Priority Data
Sep. 17, 2013 (CN) 201310425474.6

(51) Int. Cl. G06F 21/60

(52) U.S. Cl. CPC G06F 21/60
USPC 726/26

(57) ABSTRACT

The present invention discloses an information processing method and an electronic device so as to address such a technical problem in the convention that data can not be protected from being misappropriated by another person while ensuring a rapid and convenient daily access of the user to the data. The method is applicable to a first electronic device and includes: obtaining first data; dividing the first data into a first part of data and a second part of data where the first part of data satisfies a first dimension and the second part of data satisfies a second dimension, and there is an association relationship of the first dimension with the second dimension, wherein the first electronic device characterizes a response result as a response failure when obtaining a second instruction for the first part of data and responding to the second instruction with the first part of data; and the first electronic device characterizes the response result as a response failure after obtaining a third instruction for the second part of data and responding to the third instruction with the second part of data; storing the first part of data on a first storage unit of the first electronic device; and storing the second part of data on a second storage unit.

The present application claims the priority of Chinese Patent Application No. 201310425474.6, entitled as “Information processing method and electronic device”, and filed with the Chinese Patent Office on Sep. 17, 2013, the contents of which are incorporated herein by reference in its entirety.

### FIELD OF THE INVENTION

The present invention relates to the field of electronics technology and in particular to an information processing method and an electronic device.

### BACKGROUND OF THE INVENTION

There have been an increasing number of types of electronic devices with increasingly powerful functions to bring convenience to the life of people and production by people along with constant development of electronics technology.

In the information era today, people may have various types of personal data (e.g., address books, schedule data, e-mail data, etc.), including private data undesirable for users to be retrieved by other users, stored in their electronic devices (e.g., handsets, tablet computers, etc.). In the convention, the users in need of protecting the private data will protect these data by their passwords, and corresponding keys have to be entered manually each time these data are invoked by the users.

However the inventors of this application have identified at least the following technical problem in the convention during making of a technical solution according to embodiments of this application:

In practice, a user needs to protect some data from being misappropriated but may also access these data frequently, e.g., contact information in an address book, and if these data are protected by a password as in the convention, then the user has to enter the password manually each time the data are invoked, so that an additional period of time of the user will be spent, and also the user may fail to invoke the data because the user forgets his or her key or enters the key with an operational error, both of which may result in an unnecessary trouble to the user. In other words, there is such a technical problem in the convention that the data can not be protected from being misappropriated by another person while ensuring a rapid and convenient daily access of the user to the data.

### SUMMARY OF THE INVENTION

This application provides an information processing method and an electronic device so as to address such a technical problem in the convention that data can not be protected from being misappropriated by another person while ensuring a rapid and convenient daily access of the user to the data so as to achieve such a technical effect that the user can have a daily access to the protected data without entering manually any key while having the data protected from being misappropriated by another person when the electronic device is under an unsecured condition.

In an aspect, this application provides an information processing method, applicable to a first electronic device, the method including: obtaining first data, wherein the first electronic device characterizes a response result as a response success when obtaining a first instruction for the first data and responding to the first instruction with the first data; dividing the first data into a first part of data and a second part of data where the first part of data satisfies a first dimension and the second part of data satisfies a second dimension, and there is an association relationship of the first dimension with the second dimension, wherein the first electronic device characterizes the response result as a response failure when obtaining a second instruction for the first part of data and responding to the second instruction with the first part of data; and the first electronic device characterizes the response result as a response failure when obtaining a third instruction for the second part of data and responding to the third instruction with the second part of data; storing the first part of data on a first storage unit of the first electronic device; and storing the second part of data on a second storage unit.

Preferably a second security parameter value of the second storage unit to characterize data security is higher than a first security parameter value of the first storage unit to characterize data security.

Preferably the second storage unit is particularly a storage unit of a second electronic device, and the method further includes: establishing a secured data channel of the first electronic device with the second electronic device upon determining presence of the second electronic device in a preset range.

In another aspect, this application provides an information processing method, applicable to a first electronic device including a first storage unit in which a first part of data in a first dimension is stored, the method including: detecting a first manipulation operation on the first part of data; obtaining a current third security parameter; judging whether the third security parameter satisfies a preset security condition; determining a second part of data in a second dimension, stored on a second storage unit, associated with the first part of data according to a mapping relationship table in the event that the third security parameter satisfies the preset security condition; responding to the first manipulation operation with the first part of data and the second part of data and characterizing a first response result of the first operation as a response success; and characterizing a second response result of the first operation as a response failure in the event that the third security parameter does not satisfy the preset security condition

Preferably the second storage unit is particularly a storage unit of a second electronic device, wherein the third security parameter is particularly the distance the distance of the first electronic device from the second electronic device; and the preset security condition is particularly a preset security distance range of the first electronic device from the second electronic device.

Preferably the determining the second part of data in the second dimension, stored on the second storage unit, associated with the first part of data according to the mapping relationship table in the event that the third security parameter satisfies the preset security condition includes: determining an intermediate code associated with the first part of data according to a first mapping relationship table stored on the first electronic device in the event that the distance the distance of the first electronic device from the second electronic device satisfies the preset security condition; and sending a first request to the second electronic device so that the second electronic device responds to the first request by searching according to a second mapping relationship stored in the second electronic device for the second part of data associated with the first intermediate code and sending the second part of data to the first electronic device.

Preferably the responding to the first manipulation operation with the first part of data and the second part of data and characterizing the first response result of the first operation as a response success includes: receiving the second part of data sent from the second electronic device and storing the second part of data in a third storage unit; responding to the first manipulation operation with the first part of data and the second part of data; and characterizing the first response result as a response success and removing the second part of data from the third storage unit.

Preferably the second storage unit is particularly a storage unit of a second electronic device, and the responding to the first manipulation operation with the first part of data and the second part of data and characterizing the first response result of the first operation as a response success includes: sending a second request to the second electronic device so that the second electronic device responds to the first request by responding to the first manipulation operation with the second part of time; responding to the first manipulation operation with the first part of data while sending the second request to the second electronic device; and characterizing the first response result as a response success.

In a further aspect, this invention provides an electronic device including: a first obtainment unit configured to obtain first data, wherein the first electronic device characterizes a response result as a response success when obtaining a first instruction for the first data and responding to the first instruction with the first data; a first control unit configured to divide the first data into a first part of data and a second part of data so that the first part of data satisfies a first dimension and the second part of data satisfies a second dimension, and there is an association relationship of the first dimension with the second dimension, wherein the first electronic device characterizes the response result as a response failure when obtaining a second instruction for the first part of data and responding to the second instruction with the first part of data; and the first electronic device characterizes the response result as a response failure when obtaining a third instruction for the second part of data and responding to the third instruction with the second part of data; a second control unit configured to store the first part of data on a first storage unit of the first electronic device; and a third control unit configured to store the second part of data on a second storage unit.

Preferably the a second security parameter value of the second storage unit to characterize data security is higher than a first security parameter value of the first storage unit to characterize data security.

Preferably the second storage unit is a storage unit of the second electronic device, the electronic device further includes: a fourth control unit, configured to establish a secure data channel between the first electronic device and the second electronic device, when it is determined that the second electronic device is within the preset range.

In still another aspect, this invention provides an electronic device including a first storage unit in which a first part of data in a first dimension is stored, the electronic device further including: a first detection unit configured to detect a first manipulation operation on the first part of data; a second obtainment unit configured to obtain a current third security parameter; a first judgment unit configured to judge whether the third security parameter satisfies a preset security condition; a fifth control unit configured to determine a second part of data in a second dimension, stored on a second storage unit, associated with the first part of data according to a mapping relationship table in the event that the third security parameter satisfies the preset security condition; a sixth control unit configured to respond to the first manipulation operation with the first part of data and the second part of data and to characterize a first response result of the first operation as a response success; and a seventh control unit configured to characterize a second response result of the first operation as a response failure in the event that the third security parameter does not satisfy the preset security condition.

Preferably the second storage unit is particularly a storage unit of a second electronic device, wherein the third security parameter is particularly the distance the distance of the first electronic device from the second electronic device; and the preset security condition is particularly a preset security distance range of the first electronic device from the second electronic device.

Preferably the fifth control unit includes: a first determination module configured to determine an intermediate code associated with the first part of data according to a first mapping relationship table stored on the first electronic device in the event that the distance the distance of the first electronic device from the second electronic device satisfies the preset security condition; and a first control module configured to send a first request to the second electronic device so that the second electronic device responds to the first request by searching according to a second mapping relationship stored in the second electronic device for the second part of data associated with the first intermediate code and sending the second part of data to the first electronic device.

Preferably the sixth control unit includes: a second control module configured to receive the second part of data sent from the second electronic device and to store the second part of data in a third storage unit; a third control module configured to respond to the first manipulation operation with the first part of data and the second part of data; and a fourth control module configured to characterize the first response result as a response success and to remove the second part of data from the third storage unit.

Preferably the second storage unit is particularly a storage unit of a second electronic device, and the sixth control unit includes: a fifth control module configured to send a second request to the second electronic device so that the second electronic device responds to the first request by responding to the first manipulation operation with the second part of time; a sixth control module configured to respond to the first manipulation operation with the first part of data while sending the second request to the second electronic device; and a seventh control module configured to characterize the first response result as a response success.

One or more of the technical solutions according to the embodiments of this application have at least the following technical effects or advantages:

1. Since in the embodiments of this application, the first part of data in the first dimension of the first data is stored in the first storage unit of the first electronic device, and the second part of data in the second dimension is stored in the second storage unit, and when the first part of data itself responds alone to the invocation operation by the user, the response will not succeed; and only if the first electronic device is determined to be under a secured condition, then the first electronic device will interact with the second electronic device and respond successfully to the invocation operation by the user with both the first part of data and the second part of data. Thus even if the first electronic device is lost, then another person can only retrieve the first part of data in the single dimension from the first electronic device, and the data in the single dimension can not respond to any invocation operation by the user and will be useless so that the other person can not misappropriate the first data, thereby guaranteeing the security of the first data. When the first electronic device is under a secured condition, the user can invoke an application without entering manually any key, and the data can be protected completely at the background without distributing the user at the foreground to thereby address such a technical problem in the convention that data can not be protected from being misappropriated by another person while ensuring a rapid and convenient daily access of the user to the data so as to achieve such a technical effect that the user can have a daily access to the protected data without entering manually any key while having the data protected from being misappropriated by another person when the electronic device is under an unsecured condition.

2. Since in the embodiments of this application, the second part of data with higher required security is stored on the second storage unit with more strictly security requirement, so that another person stealing the first electronic device can only retrieve the first part of data in the single dimension but can not retrieve the more important second part of data, thereby enhancing the security of the first data.

3. Since in the embodiments of this application, the first part of data and the second part of data can be associated indirectly by an intermediate code, so that another person can not search the mapping relationship table of the first part of data to the second part of data for the second part of data, thereby enhancing the security of the data.

### BRIEF DESCRIPTION OF THE DRAWINGS

FIG. 1 illustrates an information processing method according to an embodiment of this application;

FIG. 2 illustrates an information processing method according to another embodiment of this application;

FIG. 3 illustrates an information processing method according to a further embodiment of this application;

FIG. 4 illustrates an information processing method according to still another embodiment of this application;

FIG. 5 illustrates a schematic diagram of an electronic device according to an embodiment of this application;

FIG. 6 illustrates a schematic diagram of an electronic device according to another embodiment of this application;

FIG. 7 illustrates a schematic diagram of an electronic device according to a further embodiment of this application; and

FIG. 8 illustrates a schematic diagram of an electronic device according to still another embodiment of this application.

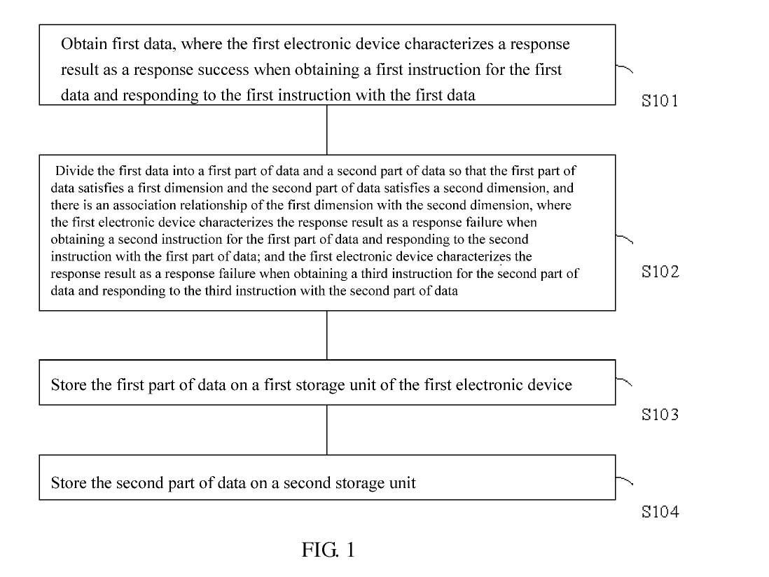

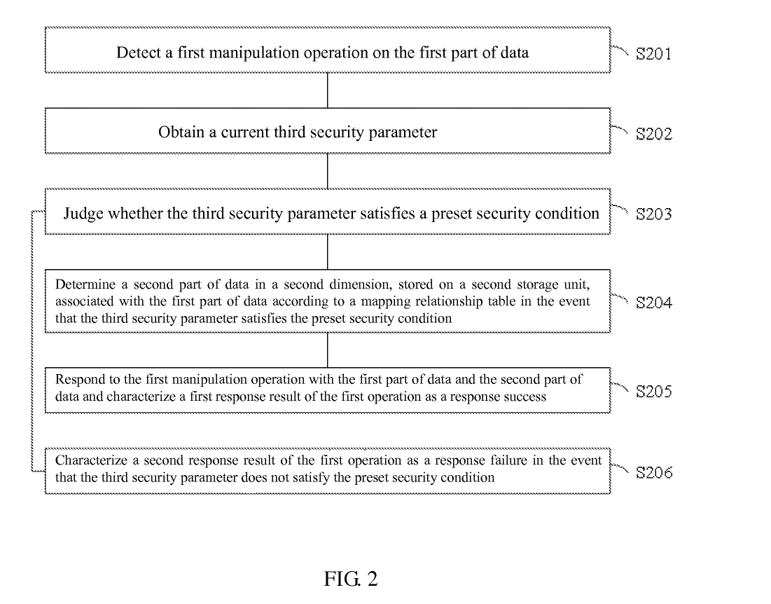

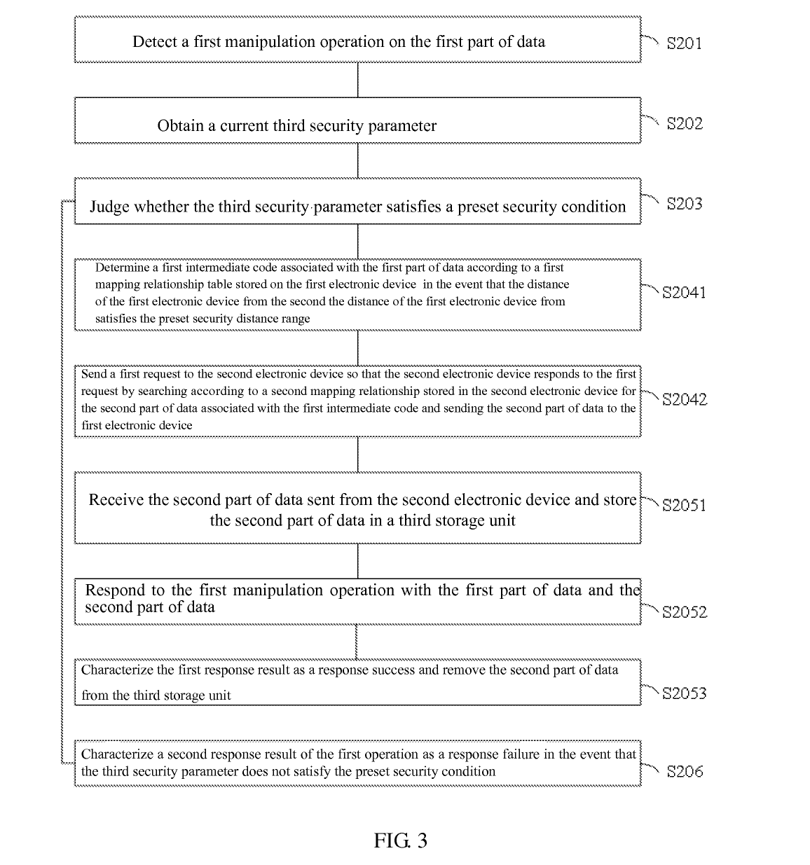

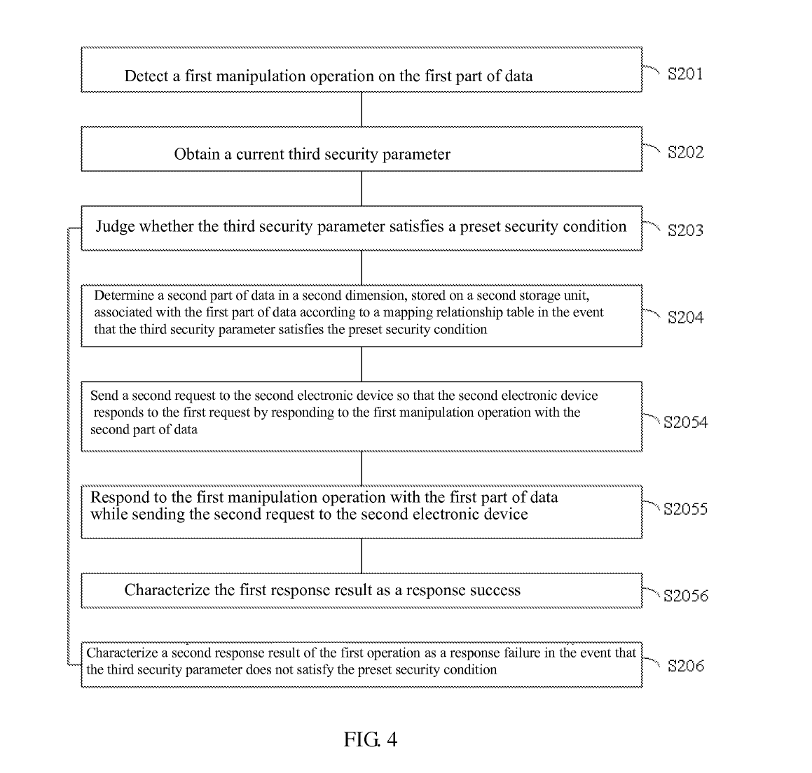

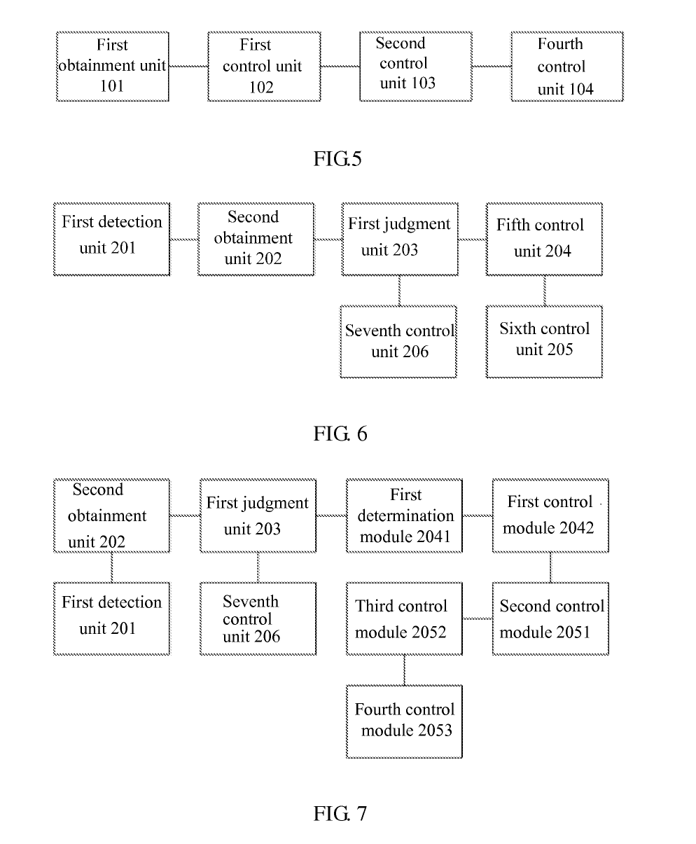

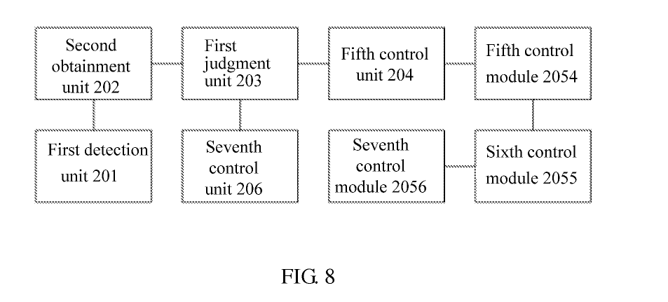

### DETAILED DESCRIPTION OF THE INVENTION

This application provides an information processing method and an electronic device so as to address such a technical problem in the convention that data can not be protected from being misappropriated by another person while ensuring a rapid and convenient daily access of the user to the data so as to achieve such a technical effect that the user can have a daily access to the protected data without entering manually any key while having the data protected from being misappropriated by another person when the electronic device is under an unsecured condition.

The technical solutions of this application will be detailed below with reference to the drawings and particular embodiments thereof, and it shall be appreciated that the embodiments of this application and particular features in the embodiments relate to a detailed description of the technical solutions of this application but are not intended to limit the technical solutions of this application, and the embodiments of this application and the particular features in the embodiments can be combined with each other unless there is any collision.

### First Embodiment

In an aspect, there is provided according to a first embodiment of this application an information processing method applicable to a first electronic device which can be a smart handset, a tablet computer, a wearable smart device (e.g., smart glasses, a smart watch, etc.) or another smart device, and the method includes the following steps:

S101 is to obtain first data, where the first electronic device characterizes a response result as a response success when obtaining a first instruction for the first data and responding to the first instruction with the first data;

S102 is to divide the first data into a first part of data and a second part of data so that the first part of data satisfies a first dimension and the second part of data satisfies a second dimension, and there is an association relationship of the first dimension with the second dimension, where the first electronic device characterizes the response result as a response failure when obtaining a second instruction for the first part of data and responding to the second instruction with the first part of data; and the first electronic device characterizes the response result as a response failure when obtaining a third instruction for the second part of data and responding to the third instruction with the second part of data;

S103 is to store the first part of data on a first storage unit of the first electronic device; and

S104 is to store the second part of data on a second storage unit.

Specifically the first data are data in at least two dimensions, e.g., contact information data in an address book of a handset, including a first part of data in a first dimension which are names of contacts and a second part of data in a second dimension which handset numbers, email boxes, social contact manners, etc., of the contacts.

When a user invokes the first data, if the electronic device responds to the invocation operation with the first data as a whole, then there will be a successful response to the invocation. For example, the user enters via his or her voice, e.g., “Dialing to some contact”, and at this time if the electronic device responds to the operation with two-dimension data of the contact including a name and a phone number, then there will be a successful response to the dialing operation.

When the electronic device responds to the invocation operation by the user only with the first part of data or the second part of data, there will no successful response to the dialing operation. For example, when the user selects a contact name in the address book, if the operation is responded to only with name data of the user, then there will be no successful response to the dialing operation; and alike if there are only phone number data, then when the user going to send a short message to another person enters the name of the corresponding target contact into his or her handset, there will be no successful response to the invocation operation either.

Thus the electronic device can distribute storage of the first data in at least two data dimensions for protection thereof when obtaining the first data particularly in the following two implementations:

Firstly the data are stored by storing the two dimensions in the first data separately; and

Secondly the data are stored by storing the first data completely at a first storage location and then separating data in one dimension of the first data for separate storage. For example, after the user imports the address book, the user can choose to separate the data in the dimension of phone numbers for separate storage into the second storage unit.

The second storage unit can be located particularly in the following three scenarios:

(1) The second storage unit is located in a second electronic device, for example, the first storage unit is a memory of a handset, and the second storage unit is a memory of a smart watch; and in this case, if the second part of data among the first data is separated and stored in the second storage unit, then the data can be sent over a communication network common to the first electronic device and the second electronic device, or the data can be sent through wireless communication between the first electronic device and the second electronic device (e.g., NFC, Bluetooth, infrared, etc.).

(2) The second storage unit is a storage space provided by a cloud server; and in this case, if the second part of data among the first data is separated and stored in the second storage unit, then the data can be sent over a communication network

(3) The second storage unit is another storage unit, located on the first electronic device, different from the first storage unit. For example, the first storage unit is a memory of a handset, and the second storage unit is an extended SD memory card of the handset.

Thus with the foregoing technical solution, it can be ensured that neither the first part of data in the first storage unit nor the second part of data in the second storage unit can respond alone to the invocation operation by the user to thereby ensure the security of the first data. When the first electronic device is in a secured condition, the electronic device will communicate spontaneously with the second electronic device upon detection of the invocation operation by the user to retrieve the second part of data from the second storage unit and respond to the invocation operation with both the first part of data and the second part of data so as to respond successfully to the invocation operation by the user.

A particular secured condition of the first electronic device can be set dependent upon a real use environment and use habit of the use:

For example, when the first storage unit is a memory of a handset, and the second storage unit is a memory of a smart watch, a secured condition of the handset can be set that there is a distance from the smart watch in a preset range because the smart watch is worn all the time on an arm of the user and under a secured condition so that the handset can be ensured to be in a secured environment so long as there is a distance of the handset from the smart watch in a specific range (e.g., in 2 meters);

In another example, when the first storage unit is a memory of a handset, and the second storage unit is a cloud server, a secured condition of the handset can be set that when the handset currently accesses a wireless network at a specific IP address, for example, currently at an IP address at home, the handset can be ensured to be in a secured environment; and

In still another example, when the first storage unit is a memory of a handset, and the second storage unit is an extended SD memory card of the handset, a secured condition of the handset can be set that a current manipulation operation by the user to invoke the first data corresponds to a fingerprint or a voiceprint agreeing with a preset fingerprint or voiceprint, and when they agree with each other, the handset can be determined to be in a secured environment.

Since in the embodiments of this application, the first data can be data-protected by separating the first data as per the dimensions thereof into the first part of data in the first dimension for storage in the first storage unit and the second part of data in the second dimension for storage in the second storage unit, and when the first part of data or the second part data responds alone to the invocation operation by the user, the response will not succeed; and only if the first electronic device is determined to be under a secured condition, then the first electronic device will retrieve the second part of data from the second storage unit and respond successfully to the invocation operation by the user with both the first part of data and the second part of data.

Thus even if the first electronic device is lost, then another person can only retrieve the first part of data in the single dimension from the first electronic device, and the data in the single dimension can not respond to any invocation operation by the user and will be useless so that the other person can not misappropriate the first data, thereby guaranteeing the security of the first data. When the first electronic device is under a secured condition, the user can invoke an application without entering manually any key, and the data can be protected completely at the background without distributing the user at the foreground to thereby address such a technical problem in the convention that data can not be protected from being misappropriated by another person while ensuring a rapid and convenient daily access of the user to the data so as to achieve such a technical effect that the user can have a daily access to the protected data without entering manually any key while having the data protected from being misappropriated by another person when the electronic device is under an unsecured condition.

In practice, there is a difference in required security level between the data in the two dimensions of the first data, for example, there is higher required security of data with an attribute of phone numbers than data with an attribute of names in an address book, so in an embodiment of this application, a second security parameter value of the second storage unit to characterize data security is higher than a first security parameter value of the first storage unit to characterize data security. Furthermore the first data can be separated into the two dimensions for distributed storage of the first data by storing the second part of data with higher required security into the second storage unit to further enhance the security of the first data.

Specifically the second security parameter value of the second storage unit is higher because it is more difficult to retrieve the second part of data therein alone, for example, when the second storage unit is a memory of a smart watch, it can be prescribed that the second part of data therein be managed only if the smart watch is connected with a preset computer or that the second part of data be sent to the first electronic device only if a request thereof to invoke the second part of data is received, where the second part of data can not be invoked from a control panel of the smart phone alone, and the data in the storage unit of the smart watch can not be retrieved even if is removed and connected with another computer.

As described above, the second storage unit can be a storage unit of a second electronic device, and in this case, when the first electronic device is determined to be under a secured condition, the first electronic device will respond to the manipulation operation by the user to invoke the data by sending a request to the second electronic device to retrieve the second part of data and then responding to the invocation operation by the user with both the data in the two dimensions. That is, in an embodiment of this application, the second storage unit is particularly a storage unit of a second electronic device, and after the second part of data is stored on the second storage unit, the method further includes:

A secured data channel of the first electronic device with the second electronic device is established upon determining the presence of the second electronic device in a preset range.

Specifically when the first storage unit is a memory of a handset, and the second storage unit is a memory of a smart watch, a secured condition of the handset can be set that there is a distance from the smart watch in a preset range because the smart watch is worn all the time on an arm of the user and under a secured condition so that the handset can be ensured to be in a secured environment so long as there is a distance of the handset from the smart watch in a specific range (e.g., in 2 meters). At this time the first electronic device and the second electronic device can communicate the data over a communication network common to them or a wireless communication medium (e.g., NFC, Bluetooth, etc.) between them, and specifically the first electronic device can send a request instruction to the second electronic device over the secured data channel, and the second electronic device can send the second part of data to the first electronic device over the secured data channel.

Thus when the first electronic device is determined to be under a secured condition, the first electronic device can establish a secured data channel with the second electronic device and send the data over the secured channel to respond successfully the invocation operation by the user on the data.

### Second Embodiment

In another aspect, there is provided according to a second embodiment of this application another information processing method applicable to a first electronic device including a first storage unit in which a first part of data in a first dimension is stored; and specifically the first electronic device can be a smart handset, a tablet computer, a wearable smart device (e.g., smart glasses, a smart watch, etc.) or another smart device; and the first part of data in the first dimension refers to data having a mapping relationship with data in another dimension and constituting together with the data in the other dimension a piece of integral data, e.g., the name of a contact in an address book, which is data in a single dimension, where the data in the single dimension can only constitute a piece of integral information of the address book together with its associated phone number, email box, social contact manner and data in other dimensions.

In the embodiment of the invention, the method includes the following steps:

S201 is to detect a first manipulation operation on the first part of data.

Specifically the first manipulation operation by a user to invoke the first part of data is detected, where the manipulation operation can particularly be to press a physical key, to touch-control a touch screen, to control via voice or other manipulation operations.

S202 is to obtain a current third security parameter.

Specifically a current secured condition of the first electronic device is obtained. The third security parameter can be set dependent upon a particular condition, for example, set as the distance of the first electronic device from the second electronic device or as a network where the first electronic device is current located or as a user fingerprint or a user voiceprint corresponding to the first manipulation operation or the like, which will not be enumerated in the embodiment of this embodiment.

S203 is to judge whether the third security parameter satisfies a preset security condition.

Stated otherwise, it is judged whether the third security parameter satisfies the preset security condition particularly dependent upon an attribute of the third security parameter, for example, when the third security parameter is the distance be the distance the distance of the first electronic device from the second electronic device, it is judged whether the distance is in a specific range (e.g., 2 meters); in another example, if the third security parameter is a network where the first electronic device is current located, then it is judged whether the IP of the network is a preset IP; and in still another example, if the third security parameter is a user fingerprint or a user voiceprint corresponding to the first manipulation operation, then it is judged whether the fingerprint or the voiceprint is a preset fingerprint or voiceprint.

S204 is to determine a second part of data in a second dimension, stored on a second storage unit, associated with the first part of data according to a mapping relationship table in the event that the third security parameter satisfies the preset security condition.

Specifically the second part of data in a second dimension associated with the first part of data is stored in the second storage unit which is particularly located as in the previous embodiment, including three scenarios of being located in the second electronic device, in a storage space of a cloud server and in another storage unit, in the first electronic device, different from the first storage unit. When the third security parameter characterizes that the first electronic device is currently under a secured condition, the first electronic device will determine the second part of data stored on the second storage unit according to the mapping relationship table associated with the first part of data particularly in the following three implementations:

Firstly, the first electronic device determines from a first mapping relationship stored locally an identifier of the second part of data associated therewith in the second storage unit and sends a request instruction for the identifier to the second electronic device. The identifier can particularly be a storage location of the second part of data in the second storage unit or a code thereof in the second storage unit, where the identifier is used primarily for the purpose of reserving plaintext information of the second part of data in a first mapping relationship table of the first electronic device to enhance the security of the data. The plaintext information of the second part of data can also be embodied in the first mapping relationship table if necessary in view of a tradeoff between a response speed, calculation complexity and data security, and this application will not be limited in this regard.

Secondly, the first electronic device only sends a request to the second storage unit for the second part of data associated with the first part of data, and the second storage unit will receive the request instruction and respond thereto by searching a second mapping relationship table stored on the second storage unit for the second part of data associated with the first part of data.

Thirdly, in order to enhance the security of the data, the first part of data and the second part of data are associated by an intermediate code. Specifically the first electronic device determines from the first mapping relationship table stored locally an intermediate code associated with the first part of data and sends a request for the intermediate code to the second storage unit, and the second storage unit will receive the request instruction and respond thereto by searching the second mapping relationship table stored on the second storage unit for the second part of data associated with the intermediate code.

S205 is to respond to the first manipulation operation with the first part of data and the second part of data and to characterize a first response result of the first operation as a response success.

Specifically the first manipulation operation by the user will be responded to after the second part of data associated with the first part of data are determined particularly as follows:

(1) The first electronic device sends a request to the second storage unit for the second part of data to be sent from the second electronic device thereto, and the first electronic device combines the first part of data and the second part of data upon reception of the second part of data to respond therewith to the first manipulation operation as a first response which is a successful response.

(2) The first electronic device sends a request to the second storage unit for a virtual unified system to be composed of the second electronic device and the first electronic device, and then the first electronic device of the virtual system responds to the first manipulation operation with the first part of data, and also the second electronic device of the virtual system responds to the first manipulation operation with the second part of data, so that the virtual system can respond successfully the first manipulation operation.

S206 is to characterize a second response result of the first operation as a response failure in the event that the third security parameter does not satisfy the preset security condition.

Specifically if the third security parameter characterizing the current security condition of the first electronic device does not reach the preset security condition, then there will be no successful response to the first manipulation operation by the user. In practice, there will be simply no response to the manipulation operation; or the manipulation operation will be responded to only with the first part of data, and in this case, the first part of data in the single dimension can not respond successfully to the first manipulation operation by the user to invoke the data. For example, when the user selects a contact name in an address book for dialing thereto, if the operation is responded to only with the name of the user, then there will be no successful response to the dialing operation; and also if there are only phone number data, then when the user going to send a short message to another person enters the name of the corresponding target contact into his or here handset, there will be no successful response to the invocation operation either.

Since in the embodiments of this application, the first part of data in the first dimension of the first part is stored in the first storage unit of the first electronic device, and the second part of data in the second dimension is stored in the second storage unit, and when first part of data itself responds alone to the invocation operation by the user, the response will not succeed; and only if the first electronic device is determined to be under a secured condition, then the first electronic device will interact with the second electronic device and respond successfully to the invocation operation by the user with both the first part of data and the second part of data.

Thus even if the first electronic device is lost, then another person can only retrieve the first part of data in the single dimension from the first electronic device, and the data in the single dimension can not respond to any invocation operation by the user and will be useless so that the other person can not misappropriate the first data, thereby guaranteeing the security of the first data. When the first electronic device is under a secured condition, the user can invoke an application without entering manually any key, and the data can be protected completely at the background without distributing the user at the foreground to thereby address such a technical problem in the convention that data can not be protected from being misappropriated by another person while ensuring a rapid and convenient daily access of the user to the data so as to achieve such a technical effect that the user can have a daily access to the protected data without entering manually any key while having the data protected from being misappropriated by another person when the electronic device is under an unsecured condition.

As described above, the second storage unit can be a storage unit of a second electronic device, and in this case:

The third security parameter is particularly the distance the distance of the first electronic device from the second electronic device; and

The preset security condition is particularly a preset security distance range of the first electronic device from the second electronic device.

Thus so long as the first electronic device is in the preset security distance range from the second electronic device, the first electronic device can be determined to be under a secured condition, and the first electronic device can interact with the second electronic device to respond to the first manipulation operation of the user; and when the first electronic device goes beyond the preset security distance range from the second electronic device, the first electronic device can not interact with the second electronic device, and there will be no successful response to the first manipulation operation by the user. The entire process will not involve any key entry by the user, and the data can be protected completely at the background without distributing a daily access of the user to the data and greatly improve an access experience of the user.

As described above, in order to enhance the security of the data, the first part of data and the second part of data are associated by an intermediate code. That is, in an embodiment of this application, the second part of data in the second dimension, stored on the second storage unit, associated with first part of data is determined according to a first association relationship in the event that the third security parameter satisfies the preset security condition in the step 204 as follows:

S2041 is to determine a first intermediate code associated with the first part of data according to a first mapping relationship table stored on the first electronic device in the event that the distance of the first electronic device from the second the distance of the first electronic device from satisfies the preset security distance range; and

S2042 is to send a first request to the second electronic device so that the second electronic device responds to the first request by searching a second mapping relationship stored in the second electronic device for the second part of data associated with the first intermediate code and sending the second part of data to the first electronic device.

Since in the embodiments of this application, the first part of data and the second part of data are associated indirectly by an intermediate code instead of being associated directly, even if the first electronic device is stolen, then another person can only know the first part of data in the single dimension of no use in practice from the first electronic device and also can only determine the intermediate code useless in practice associated with the first part of data from the first mapping relationship table, thereby ensuring that the data of the user will not be misappropriated by the other person.

As described above, the first electronic device can respond to the first manipulation operation by instructing the second electronic device to send the second part of data thereto and responding to the manipulation operation by the user with both the data in the two dimensions. That is, in an embodiment of this application, in the step S205, the first manipulation operation is responded to with the first part of data and the second part of data and the first response result of the first operation is characterized as a response success particularly as follows:

S2051 is to receive the second part of data sent from the second electronic device and to store the second part of data in a third storage unit.

Specifically the third storage unit can be another storage unit, on the first electronic device, different from the first storage unit or can be the first electronic device itself, and the embodiment of this application will not be limited in this regard. The first electronic device stores the second part of data on the third storage unit upon reception thereof.

S2052 is to respond to the first manipulation operation with the first part of data and the second part of data.

Specifically the first electronic device will respond to the first manipulation operation with both the data in the two dimensions, where the first electronic device can combine the first part of data and the second part of data into the first data in the third storage unit or the first storage unit and respond to the first manipulation operation by the user with the first data; or can combine the first part of data and the second part of data in an operating memory of the first electronic device instead of combining them physically in the first storage unit or the third storage unit and respond to the first manipulation operation by the user with the first data as a result of the combination.

Since the operating memory is volatile, an advantage of combining the data in the two dimensions in the operating memory is that the whole access trace of the first data will not be left in the storage space of the first electronic device to thereby further guarantee the security of the first data.

S2053 is to characterize the first response result as a response success and to remove the second part of data from the third storage unit.

Specifically if the first manipulation operation by the user is responded with both the data in the two dimensions, then the response will succeed. After the successful response, in order to guarantee the security of the data, all the information about the second part will be removed from the third storage unit. Moreover in order to avoid the first data and the second part of data and its association relationship with the first part of data from being recorded by the relevant application in the first electronic device when the first manipulation operation is responded successfully to, a privilege to access the first part of data by another application can be restricted so that the application can not record the relevant information. For example, when the first part of data is the name of a contact, then a privilege to retrieve an address book by another application will be restricted so that information about the contact can not be retrieved, and an application provider or another person will be restrained from misappropriating the information about the contact of the user through the application. Furthermore only a name relevant to communication but no phone number relevant to the name can be recorded in a local communication record.

As described above, the first manipulation operation of the user can be responded to by forming a virtual unified system from the first electronic device and the second electronic device and responding to the first manipulation operation by the virtual system instead of retrieving the second part of data from the second storage unit. That is, in an embodiment of this application, in the step 205, the second storage unit is particularly a storage unit of a second electronic device, and the first manipulation operation is responded with the first part of data and the second part of data and the first response result of the first operation is characterized as a response success particularly as follows:

S2054 is to send a second request to the second electronic device so that the second electronic device responds to the first request by responding to the first manipulation operation with the second part of data;

S2055 is to respond to the first manipulation operation with the first part of data while sending the second request to the second electronic device; and

S2056 is to characterize the first response result as a response success.

By way of an example where the first electronic device is a tablet computer, the second storage unit is a cloud server, and the first part of data is a local icon of a financial application, and the second part of data is an application of the financial application stored at the cloud server, the third security parameter is assumed as a touch control fingerprint of the first manipulation operation by the user to invoke the first part of data, and when the touch control fingerprint agrees with a preset fingerprint, the first electronic device is determined to be in a secured environment, and the first electronic device will send a request instruction to the cloud server, the cloud server responds to the request instruction by forming with the first electronic device a virtual unified system, so that the first electronic device can respond to the invocation operation by the user directly over the virtual platform to perform financial management without downloading locally the financial application itself and data therein. If the touch control fingerprint disagrees with the preset fingerprint, then there will be no successful response to the manipulation operation by the user.

Only the scenario with the first data in the two dimensions has been described in the respective technical solutions according to the embodiments of this application, and in practice, the first data can be in more than two dimensions and data-protected as in the foregoing technical solutions, for example, the first data is contact information in three dimensions including a first dimension of a name, a second dimension of a phone number and a third dimension of an email box, and the first data can be protected by storing the name in the first dimension in a storage space local to the first electronic device, the phone number in the second dimension in a storage space of the second electronic device and the email box address in the third dimension in a third electronic device; or by combing the data in the second dimension and the third dimension together for storage in the storage space of the second electronic device, which will not be enumerated here in this application.

### Third Embodiment

In a further aspect, there is according to a third embodiment of this application an electronic device including:

A first obtainment unit 101 is configured to obtain first data, where the first electronic device characterizes a response result as a response success when obtaining a first instruction for the first data and responding to the first instruction with the first data;

A first control unit 102 is configured to divide the first data into a first part of data and a second part of data so that the first part of data satisfies a first dimension and the second part of data satisfies a second dimension, and there is an association relationship of the first dimension with the second dimension, where the first electronic device characterizes the response result as a response failure when obtaining a second instruction for the first part of data and responding to the second instruction with the first part of data; and the first electronic device characterizes the response result as a response failure when obtaining a third instruction for the second part of data and responding to the third instruction with the second part of data;

A second control unit 103 is configured to store the first part of data on a first storage unit of the first electronic device; and

A third control unit 104 is configured to store the second part of data on a second storage unit.

In practice, there is a difference in required security level between the data in the two dimensions of the first data, for example, there is higher required security of data with an attribute of phone numbers than data with an attribute of names in an address book, so in an embodiment of this application, a second security parameter value of the second storage unit to characterize data security is higher than a first security parameter value of the first storage unit to characterize data security. Furthermore the first data can be separated into the two dimensions for distributed storage of the first data by storing the second part of data with higher required security into the second storage unit to further enhance the security of the first data.

In an embodiment of this application, the second storage unit can be a storage unit of a second electronic device, and in this case, when the first electronic device is determined to be under a secured condition, the first electronic device will respond to a manipulation operation by a user to invoke the data by sending a request to the second electronic device to retrieve the second part of data and then responding to the invocation operation by the user with both the data in the two dimensions. That is, the second storage unit is particularly a storage unit of a second electronic device, and the electronic device further includes:

A fourth control unit 104 is configured to establish a secured data channel of the first electronic device with the second electronic device upon determining presence of the second electronic device in a preset range.

### Fourth Embodiment

In still another aspect, there is according to a fourth embodiment of this application an electronic device including a first storage unit in which a first part of data in a first dimension is stored, and the electronic device further includes:

A first detection unit 201 is configured to detect a first manipulation operation on the first part of data;

A second obtainment unit 202 is configured to obtain a current third security parameter;

A first judgment unit 203 is configured to judge whether the third security parameter satisfies a preset security condition;

A fifth control unit 204 is configured to determine a second part of data in a second dimension, stored on a second storage unit, associated with the first part of data according to a mapping relationship table in the event that the third security parameter satisfies the preset security condition;

A sixth control unit 206 is configured to respond to the first manipulation operation with the first part of data and the second part of data and to characterize a first response result of the first operation as a response success; and

A seventh control unit 207 is configured to characterize a second response result of the first operation as a response failure in the event that the third security parameter does not satisfy the preset security condition.

Furthermore in an embodiment of this application, the second storage unit is particularly a storage unit of a second electronic device, and where:

The third security parameter is particularly the distance the distance of the first electronic device from the second electronic device; and

The preset security condition is particularly a preset security distance range of the first electronic device from the second electronic device.

In order to enhance the security of the data, the first part of data and the second part of data are associated by an intermediate code. That is, in an embodiment of this application, the fifth control unit 204 includes:

A first determination module 2041 is configured to determine an intermediate code associated with the first part of data according to a first mapping relationship table stored on the first electronic device in the event that the distance the distance of the first electronic device from the second electronic device satisfies the preset security condition; and

A first control module 2042 is configured to send a first request to the second electronic device so that the second electronic device responds to the first request by searching a second mapping relationship stored in the second electronic device for the second part of data associated with the first intermediate code and sending the second part of data to the first electronic device.

In an embodiment of this application, the first electronic device can respond to the first manipulation operation by instructing the second electronic device to send the second part of data thereto and responding to the manipulation operation by the user with both the data in the two dimensions. That is, the sixth control unit 205 includes:

A second control module 2051 is configured to receive the second part of data sent from the second electronic device and to store the second part of data in a third storage unit;

A third control module 2052 is configured to respond to the first manipulation operation with the first part of data and the second part of data; and

A fourth control module 2053 is configured to characterize the first response result as a response success and to remove the second part of data from the third storage unit.

In an embodiment of this application, the first manipulation operation of the user can be responded to by forming a virtual unified system from the first electronic device and the second electronic device and responding to the first manipulation operation by the virtual system instead of retrieving the second part of data from the second storage unit. That is, the second storage unit is particularly a storage unit of a second electronic device, and the sixth control unit 205 includes:

A fifth control module 2054 is configured to send a second request to the second electronic device so that the second electronic device responds to the first request by responding to the first manipulation operation with the second part of time;

A sixth control module 2055 is configured to respond to the first manipulation operation with the first part of data while sending the second request to the second electronic device; and

A seventh control module 2056 is configured to characterize the first response result as a response success.

The various information processing schemes in the information processing method in the previous embodiments will be equally applicable to the electronic devices according to the embodiments above, and those skilled in the art can apparently recognize from the foregoing detailed description of the information processing method the implementations of the electronic devices according to the embodiments above, so a repeated description thereof will be omitted for conciseness of the description.

One or more of the technical solutions according to the embodiments of this application have at least the following technical effects or advantages:

1. Since in the embodiments of this application, the first part of data in the first dimension of the first data is stored in the first storage unit of the first electronic device, and the second part of data in the second dimension is stored in the second storage unit, and when the first part of data itself responds alone to the invocation operation by the user, the response will not succeed; and only if the first electronic device is determined to be under a secured condition, then the first electronic device will interact with the second electronic device and respond successfully to the invocation operation by the user with both the first part of data and the second part of data. Thus even if the first electronic device is lost, then another person can only retrieve the first part of data in the single dimension from the first electronic device, and the data in the single dimension can not respond to any invocation operation by the user and will be useless so that the other person can not misappropriate the first data, thereby guaranteeing the security of the first data. When the first electronic device is under a secured condition, the user can invoke an application without entering manually any key, and the data can be protected completely at the background without distributing the user at the foreground to thereby address such a technical problem in the convention that data can not be protected from being misappropriated by another person while ensuring a rapid and convenient daily access of the user to the data so as to achieve such a technical effect that the user can have a daily access to the protected data without entering manually any key while having the data protected from being misappropriated by another person when the electronic device is under an unsecured condition.

2. Since in the embodiments of this application, the second part of data with higher required security is stored on the second storage unit with more strictly security guaranteeing, so that another person stealing the first electronic device can only retrieve the first part of data in the single dimension but can not retrieve the more important second part of data, thereby enhancing the security of the first data.

3. Since in the embodiments of this application, the first part of data and the second part of data can be associated indirectly by an intermediate code, so that another person can not search the mapping relationship table of the first part of data to the second part of data for the second part of data, thereby enhancing the security of the data.

Those skilled in the art shall appreciate that the embodiments of the invention can be embodied as a method, a system or a computer program product. Therefore the invention can be embodied in the form of an all-hardware embodiment, an all-software embodiment or an embodiment of software and hardware in combination. Furthermore the invention can be embodied in the form of a computer program product embodied in one or more computer useable storage mediums (including but not limited to a disk memory, a CD-ROM, an optical memory, etc.) in which computer useable program codes are contained.

The invention has been described in a flow chart and/or a block diagram of the method, the device (system) and the computer program product according to the embodiments of the invention. It shall be appreciated that respective flows and/or blocks in the flow chart and/or the block diagram and combinations of the flows and/or the blocks in the flow chart and/or the block diagram can be embodied in computer program instructions. These computer program instructions can be loaded onto a general-purpose computer, a specific-purpose computer, an embedded processor or a processor of another programmable data processing device to produce a machine so that the instructions executed on the computer or the processor of the other programmable data processing device create means for performing the functions specified in the flow(s) of the flow chart and/or the block(s) of the block diagram.

These computer program instructions can also be stored into a computer readable memory capable of directing the computer or the other programmable data processing device to operate in a specific manner so that the instructions stored in the computer readable memory create an article of manufacture including instruction means which perform the functions specified in the flow(s) of the flow chart and/or the block(s) of the block diagram.

These computer program instructions can also be loaded onto the computer or the other programmable data processing device so that a series of operational steps are performed on the computer or the other programmable data processing device to create a computer implemented process so that the instructions executed on the computer or the other programmable device provide steps for performing the functions specified in the flow(s) of the flow chart and/or the block(s) of the block diagram.

Although the preferred embodiments of the invention have been described, those skilled in the art benefiting from the underlying inventive concept can make additional modifications and variations to these embodiments. Therefore the appended claims are intended to be construed as encompassing the preferred embodiments and all the modifications and variations coming into the scope of the invention.

Evidently those skilled in the art can make various modifications and variations to the invention without departing from the spirit and scope of the invention. Thus the invention is also intended to encompass these modifications and variations thereto so long as the modifications and variations come into the scope of the claims appended to the invention and their equivalents.

1. An information processing method, which is applied in a first electronic device, comprising:
obtaining first data, wherein the first electronic device characterizes a response result as a response success when obtaining a first instruction for the first data and responding to the first instruction with the first data;
dividing the first data into a first part of data and a second part of data, where the first part of data satisfies a first dimension and the second part of data satisfies a second dimension, and there is an association relationship of the first dimension with the second dimension, wherein the first electronic device characterizes the response result as a response failure when obtaining a second instruction for the first part of data and responding to the second instruction with the first part of data; and the first electronic device characterizes the response result as a response failure after obtaining a third instruction for the second part of data and responding to the third instruction with the second part of data;
storing the first part of data on a first storage unit of the first electronic device; and
storing the second part of data on a second storage unit.

2. The method according to claim 1, wherein a second security parameter value of the second storage unit to characterize data security is higher than a first security parameter value of the first storage unit to characterize data security.

3. The method according to claim 1, wherein the second storage unit is particularly a storage unit of a second electronic device, and after storing the second part of data in the second storage unit, the method further comprises:
establishing a secured data channel of the first electronic device with the second electronic device upon determining presence of the second electronic device in a preset range.

4. The method according to claim 2, wherein the second storage unit is particularly a storage unit of a second electronic device, and after storing the second part of data in the second storage unit, the method further comprises:
establishing a secured data channel of the first electronic device with the second electronic device upon determining presence of the second electronic device in a preset range.

5. An information processing method, applicable to a first electronic device comprising a first storage unit in which a first part of data in a first dimension is stored, the method comprising:
detecting a first manipulation operation on the first part of data;
obtaining a current third security parameter;
judging whether the third security parameter satisfies a preset security condition;
determining a second part of data in a second dimension, stored on a second storage unit, associated with the first part of data according to a mapping relationship table in the event that the third security parameter satisfies the preset security condition;
responding to the first manipulation operation with the first part of data and the second part of data and characterizing a first response result of the first operation as a response success; and
characterizing a second response result of the first operation as a response failure in the event that the third security parameter does not satisfy the preset security condition.

6. The method according to claim 5, wherein the second storage unit is particularly a storage unit of a second electronic device, and wherein:
the third security parameter is particularly the distance the distance of the first electronic device from the second electronic device; and
the preset security condition is particularly a preset security distance range of the first electronic device from the second electronic device.

7. The method according to claim 6, wherein the determining the second part of data in the second dimension, stored on the second storage unit, associated with the first part of data according to the first association relationship table in the event that the third security parameter satisfies the preset security condition comprises:
determining a first intermediate code associated with the first part of data according to a first mapping relationship table stored on the first electronic device in the event that the distance of the first electronic device from the second electronic device satisfies the preset security distance range; and
sending a first request to the second electronic device so that the second electronic device responds to the first request by searching according to a second mapping relationship stored in the second electronic device for the second part of data associated with the first intermediate code and sending the second part of data to the first electronic device.

8. The method according to claim 7, wherein the responding to the first manipulation operation with the first part of data and the second part of data and characterizing the first response result of the first operation as a response success comprises:
receiving the second part of data sent from the second electronic device and storing the second part of data in a third storage unit;
responding to the first manipulation operation with the first part of data and the second part of data; and
characterizing the first response result as a response success and removing the second part of data from the third storage unit.

9. The method according to claim 5, wherein the second storage unit is particularly a storage unit of a second electronic device, and the responding to the first manipulation operation with the first part of data and the second part of data and characterizing the first response result of the first operation as a response success comprises:
sending a second request to the second electronic device so that the second electronic device responds to the first request by responding to the first manipulation operation with the second part of time;
responding to the first manipulation operation with the first part of data while sending the second request to the second electronic device; and
characterizing the first response result as a response success.

10. An electronic device, comprising:
a first obtainment unit configured to obtain first data, wherein the first electronic device characterizes a response result as a response success when obtaining a first instruction for the first data and responding to the first instruction with the first data;
a first control unit configured to divide the first data into a first part of data and a second part of data, where the first part of data satisfies a first dimension and the second part of data satisfies a second dimension, and there is an association relationship of the first dimension with the second dimension, wherein the first electronic device characterizes the response result as a response failure when obtaining a second instruction for the first part of data and responding to the second instruction with the first part of data; and the first electronic device characterizes the response result as a response failure after obtaining a third instruction for the second part of data and responding to the third instruction with the second part of data;
a second control unit configured to store the first part of data on a first storage unit of the first electronic device; and
a third control unit configured to store the second part of data on a second storage unit.

11. The electronic device according to claim 10, wherein a second security parameter value of the second storage unit to characterize data security is higher than a first security parameter value of the first storage unit to characterize data security.

12. The electronic device according to claim 10, wherein the second storage unit is particularly a storage unit of a second electronic device, and the electronic device further comprises:
a fourth control unit configured to establish a secured data channel of the first electronic device with the second electronic device upon determining presence of the second electronic device in a preset range.

13. The electronic device according to claim 12, wherein the second storage unit is particularly a storage unit of a second electronic device, and wherein:
the third security parameter is particularly the distance of the first electronic device from the second electronic device; and
the preset security condition is particularly a preset security distance range of the first electronic device from the second electronic device.

14. The electronic device according to claim 13, wherein the fifth control unit comprises:
a first determination module configured to determine a first intermediate code associated with the first part of data according to a first mapping relationship table stored on the first electronic device in the event that the distance of the first electronic device from the second electronic device satisfies the preset security distance range; and
a first control module configured to send a first request to the second electronic device so that the second electronic device responds to the first request by searching according to a second mapping relationship stored in the second electronic device for the second part of data associated with the first intermediate code and sending the second part of data to the first electronic device.

15. The electronic device according to claim 13, wherein the sixth control unit comprises:
a second control module configured to receive the second part of data sent from the second electronic device and to store the second part of data in a third storage unit;
a third control module configured to respond to the first manipulation operation with the first part of data and the second part of data; and
a fourth control module configured to characterize the first response result as a response success and to remove the second part of data from the third storage unit.
